(19) United States
(12) Patent Application Publication
(10) Pub. No.: US 2011/0252694 A1
(43) Pub. Date: Oct. 20, 2011

(54) COMPOSITIONS FOR DRIP FUMIGATION

(75) Inventors: Andrew Joseph Poss, Kenmore, NY (US); Rajiv Ratna Singh, Getzville, NY (US); David Nalewajek, West Seneca, NY (US); Cheryl Cantlon, Clarence Center, NY (US)

(73) Assignee: HONEYWELL INTERNATIONAL, INC., Morristown, NJ (US)

(21) Appl. No.: 12/762,801

(22) Filed: Apr. 19, 2010

(51) Int. Cl. A01M 13/00; A01P 13/00; A01P 5/00; A01N 29/00; A01P 3/00

(52) U.S. Cl. 43/125; 514/743

(57) ABSTRACT

Soil fumigation compositions are provided herein that include methyl iodide, at least one fluorocarbon or hydrofluorocarbon, at least one surfactant, and water. The fumigant can be produced by combining the water and surfactant with an initial mixture that is an azeotropic or azeotrope-like mixture of methyl iodide and at least one fluorocarbon or hydrofluorocarbon. The fumigant compositions can be utilized in drip fumigation processes, and have increased volatility as compared to methyl iodide alone, which can reduce the risk of water contamination when utilizing methyl iodide as a fumigant.

### FIELD OF THE INVENTION

The present technology relates to compositions and formulations for soil fumigation, methods of preparing such formulations, and methods of fumigating soil with such soil fumigation compositions. In particular soil fumigation compositions are provided herein that can be utilized in drip fumigation processes.

### DESCRIPTION OF RELATED ART

Historically, methyl bromide (CH₃Br) has been the most widely used and most universal fumigant in the world. It is known for being extremely effective as a herbicide, nematocide, insecticide and fungicide. Consequently, it has been used extensively for soil fumigation, as a commodity quarantine treatment for exports and imports, to control a variety of pests on numerous crops, and as a structural fumigant applied to building surfaces. However, methyl bromide contributes to the depletion of the ozone layer in the stratosphere. In accord with the Montreal Protocol, the import and manufacture of methyl bromide in the United States and other developed countries was banned in 2005.

Various compounds such as: 1, 3-dichloropropene, chloropicrin, metham sodium, and methyl iodide have been identified as alternatives to methyl bromide. One compound that stands out from the group of methyl bromide alternatives is methyl iodide (CH₃I). For example, methyl iodide has been found to be equal to or better than methyl bromide in combating weeds, nematodes, and soil pathogens. Further, methyl iodide is not associated with ozone depletion, and does not result in plant toxicity when used in effective concentrations. However, methyl iodide has a boiling point of 42.5° C. (108° F.), while methyl bromide is a gas at ambient temperature and pressure. Methyl iodide also has a lower vapor pressure and higher density than methyl bromide.

As a consequence, while methyl iodide may serve well as a fumigant, it is not a suitable drop-in replacement for methyl bromide. The term “drop-in replacement” is used when the methodology, equipment, production system, and the like, of an original material do not have to be changed significantly when using a replacement material, and that a comparable amount of the replacement material can be used for the same targets as the original material. The use of methyl iodide in existing methyl bromide equipment tends to suffer several shortcomings such as clogged tubing, material remnants in system pipes, and long line purging processes for cleaning.

Two standard methods for soil fumigation that have traditionally utilized methyl bromide (CH₃Br) include shank injection and drip application. For shank fumigation, the chemical fumigant is applied to the soil by injection through hollow shanks that are pulled through the soil either at shallow depths followed by plastic mulch film application, or at deep depths followed by surface soil compaction. Drip fumigation or chemigation involves the application of a chemical fumigant mixed with water through an irrigation system provided in raised beds of soil covered with plastic mulch or film. The irrigation system includes one or more dripperlines, which can be drip tapes, and one or more emitters installed therein. Generally, the chemical fumigant flows at a low pressure through the one or more dripperlines, which are placed below the soil surface. The fumigant slowly enters the soil from the emitters installed in the dripperlines. The drip fumigation method gives better distribution of fumigant in the soil than shank injection, allowing for lower use rates and consequently greater efficacy and reduced operations costs. Since the fumigant is applied through the closed irrigation system, there is less worker and wildlife exposure to the fumigant chemicals.

### SUMMARY OF THE INVENTION

Fumigation compositions and methods of preparing such compositions are provided herein. The fumigation compositions can be particularly useful as soil fumigation compositions in drip fumigation processes.

In one aspect, fumigant compositions are provided that include methyl iodide, at least one fluorocarbon or hydrofluorocarbon, at least one surfactant, and water.

In another aspect, methods of making a fumigant composition are provided that include: providing an initial mixture that includes methyl iodide and at least one fluorocarbon or hydrofluorocarbon; and combining the initial mixture with at least one surfactant and water to form a fumigant composition.

In a third aspect, methods of drip fumigating soil are provided that include: providing a fumigant composition to an irrigation system, the fumigant composition including methyl iodide, at least one fluorocarbon or hydrofluorocarbon, at least one surfactant, and water; and applying the fumigant composition to soil through the irrigation system.

### DETAILED DESCRIPTION

Fumigant compositions of the present technology can be prepared and utilized in drip fumigation processes in order to fumigate soil prior to planting. Generally, the fumigant compositions can include methyl iodide, at least one fluorocarbon or hydrofluorocarbon, at least one surfactant, and water. In one example, a fumigant composition can include methyl iodide in an amount from about 10% by weight to about 90% by weight of the fumigant composition, at least one fluorocarbon or hydrofluorocarbon in an amount from about 10% by weight to about 90% by weight of the fumigant composition, at least one surfactant in an amount from about 0.5% by weight to about 10% by weight of the fumigant composition, and water as the remainder of the composition. The fumigant compositions can be liquid compositions, and are preferably liquids at temperatures at or below about 60° F. (15.5° C.).

The fumigant compositions can be prepared by providing an initial mixture that includes methyl iodide and at least one fluorocarbon or hydrofluorocarbon, and combining the initial mixture with at least one surfactant and water to form a fumigant composition. The fumigant composition can be a solution or a homogeneous mixture, which can be formed by mixing the combined initial mixture, the at least one surfactant and the water under suitable conditions. In one example, the fumigant compositions can be formed by mixing the components at a temperature at or below about 60° F. (15.5° C.).

The initial mixture can be an azeotropic or azeotrope-like mixture of methyl iodide and at least one fluorocarbon or hydrofluorocarbon. In at least one example, the initial mixture can consist of or consists essentially of the methyl iodide and at least one fluorocarbon or hydrofluorocarbon, and can be a binary mixture of the methyl iodide and at least one fluorocarbon or hydrofluorocarbon.

As used herein, the term “azeotrope-like” is intended in its broad sense to include both compositions that are strictly azeotropic and compositions that behave like azeotropic mixtures. From fundamental principles, the thermodynamic state of a fluid is defined by pressure, temperature, liquid composition, and vapor composition. An azeotropic mixture is a system of two or more components in which the liquid composition and vapor composition are equal at the stated pressure and temperature. In practice, this means that the components of an azeotropic mixture are constant boiling and cannot be separated during distillation. Azeotrope-like compositions are constant boiling or essentially constant boiling. In other words, for azeotrope-like compositions, the composition of the vapor formed during boiling or evaporation (under substantially isobaric conditions) is identical, or substantially identical, to the original liquid composition. Thus, with boiling or evaporation, the liquid composition changes, if at all, only to a minimal or negligible extent. This is to be contrasted with non-azeotrope-like compositions in which, during boiling or evaporation, the liquid composition changes to a substantial degree. All azeotrope-like compositions of the invention within the indicated ranges as well as certain compositions outside these ranges are azeotrope-like. It is well known that at differing pressures, the composition of a given azeotrope will vary at least slightly, as does the boiling point of the composition. Thus, an azeotrope of A and B represents a unique type of relationship, but with a variable composition depending on temperature and/or pressure. It follows that, for azeotrope-like compositions, there is a range of compositions containing these components in varying proportions that are azeotrope-like. All such compositions are intended to be covered by the term azeotrope-like as used herein.

Methyl iodide has the chemical formula CH₃I. Methyl iodide is also known as iodomethine, and is commonly abbreviated as MeI. Methyl iodide has a boiling point of about 42.5° C., and a density of about 2.3 g/cc. An added benefit of methyl iodide is that it is not associated with ozone depletion. The methyl iodide can be present in the initial mixture in any suitable amount, including for example, in an amount from about 5 weight percent to about 70 weight percent of the initial mixture, in an amount from about 15 weight percent to about 60 weight percent of the initial mixture, or in an amount from about 25 weight percent to about 50 weight percent of the initial mixture.

The at least one fluorocarbon or hydrofluorocarbon can also be present in the initial mixture in any suitable amount, including, for example, in an amount from about 30 weight percent to about 95 weight percent of the initial mixture, in an amount from about 40 weight percent to about 85 weight percent of the initial mixture, or in an amount from about 50 weight percent to about 75 weight percent of the initial mixture. The at least one fluorocarbon or hydrofluorocarbon can be selected from suitable fluorocarbons and hydrofluorocarbons that form azeotropic or azeotrope-like binary compositions with methyl iodide. Fluorocarbons are defined herein as any carbon molecule having at least one attached fluorine group. In some examples, the at least one fluorocarbon or hydrofluorocarbon can have a boiling point of from about 0° C. to about 50° C. The at least one fluorocarbon or hydrofluorocarbon serves as a non-toxic portion of the composition, which can provide the benefit of reducing worker exposure to toxic materials.

Preferably, the at least one fluorocarbon or hydrofluorocarbon has an average Ozone Depletion Potential (ODP) of about 0.05 or less. The ozone depletion potential (ODP) of a chemical compound is the relative amount of degradation to the ozone layer it can cause, with trichlorofluoromethane (R-11) being fixed at an ODP of 1.0. Chlorodifluoromethane (R-22), for example, has an ODP of 0.05. Additionally, the at least one fluorocarbon or hydrofluorocarbon can have a 100-year Global Warming Potential (GWP) of about 1,000 or less. Global warming potential (GWP) is a measure of how much a given mass of greenhouse gas is estimated to contribute to global warming It is a relative scale which compares the gas in question to that of the same mass of carbon dioxide, whose GWP is 1 by definition. A GWP is calculated over a specific time interval and the value of this must be stated whenever a GWP is quoted. The most common time interval used currently is 100 years.

In some examples, the at least one fluorocarbon or hydrofluorocarbon can be 1,1,1,3,3-pentafluoropropane (HFC-245 fa); 1,1,1,3,3-pentafluorobutane (HFC-365); cis-1,3,3,3-tetrafluoropropene (cis-HFC-1234ze), or 1-chloro-3,3 ,3 ,-trifluoropropene (HFO-1233zd(E)).

Studies have been conducted to determine the ranges over which methyl iodide exhibits azeotropic or azeotrope-like behavior in binary mixtures with HFC-245fa, HFC-365, cis-HFC-1234ze, or HFO-1233zd(E) at pressures between 14 psia and 14.5 psia, and are described, for example, in U.S. Pat. No. 7,544,306 and in U.S. Published Application No. 2009/0041677, the disclosures of which are hereby incorporated by reference in its entirety. Table 1 below provides the temperatures and weight percentages for azeotropic or azeotrope-like binary compositions of methyl iodide and HFC-245fa as measured at an atmospheric pressure of about 14.50 psia. Table 2 below provides the temperatures and weight percentages for azeotropic or azeotrope-like binary compositions of methyl iodide and HFC-365 as measured at an atmospheric pressure of about 14.29 psia. Table 3 below provides the temperatures and weight percentages for azeotropic or azeotrope-like binary compositions of methyl iodide and cis-HFC-1234ze as measured at an atmospheric pressure of about 14.42 psia. Table 4 below provides the temperatures and weight percentages for azeotropic or azeotrope-like binary compositions of methyl iodide and HFO-1233zd(E) as measured at an atmospheric pressure of about 14.40 psia.

TABLE 1

| Wt. % | Wt. % | Temp |
|---|---|---|
| CH₃I | HFG-245fa | (° C.) |
| 0.00 | 100.00 | 14.83 |
| 0.54 | 99.46 | 14.60 |
| 1.61 | 98.39 | 14.19 |
| 4.69 | 95.31 | 13.55 |
| 9.40 | 90.60 | 12.94 |
| 14.48 | 85.52 | 12.62 |
| 19.02 | 80.98 | 12.50 |
| 23.10 | 76.90 | 12.46 |
| 26.79 | 73.21 | 12.42 |
| 30.14 | 69.86 | 12.40 |
| 33.20 | 66.80 | 12.43 |
| 36.01 | 63.99 | 12.45 |
| 38.99 | 61.01 | 12.47 |
| 41.71 | 58.29 | 12.48 |
| 44.54 | 55.46 | 12.50 |
| 47.10 | 52.90 | 12.51 |
| 49.44 | 50.56 | 12.53 |
| 51.58 | 48.42 | 12.53 |
| 53.54 | 46.46 | 12.55 |
| 55.57 | 44.43 | 12.55 |
| 57.43 | 42.57 | 12.56 |

TABLE 2

| Wt. % | Wt. % | Temp |
|---|---|---|
| CH₃I | HFG-365 | (° C.) |
| 0.0 | 100.00 | 39.2 |
| 0.5 | 99.5 | 39.2 |
| 1.1 | 98.9 | 39.2 |
| 1.6 | 98.4 | 39.1 |
| 2.1 | 97.9 | 39.0 |
| 2.6 | 97.4 | 38.4 |
| 3.2 | 96.8 | 37.8 |
| 3.7 | 96.3 | 37.5 |
| 4.2 | 95.8 | 36.8 |
| 4.7 | 95.3 | 36.2 |
| 5.1 | 94.9 | 35.9 |
| 5.6 | 94.4 | 35.6 |
| 6.1 | 93.9 | 35.5 |
| 6.6 | 93.4 | 35.4 |
| 7.1 | 92.9 | 35.0 |
| 7.5 | 92.5 | 35.1 |
| 8.0 | 92.0 | 35.4 |
| 8.4 | 91.6 | 35.1 |
| 8.9 | 91.1 | 34.8 |
| 9.3 | 90.7 | 34.5 |
| 9.8 | 90.2 | 34.2 |
| 10.2 | 89.8 | 34.1 |
| 10.7 | 89.3 | 32.8 |
| 11.1 | 88.9 | 32.7 |
| 11.5 | 88.5 | 32.6 |
| 11.9 | 88.1 | 32.5 |
| 12.4 | 87.6 | 32.4 |
| 12.8 | 87.2 | 32.4 |
| 13.6 | 86.4 | 32.3 |
| 14.4 | 85.6 | 32.2 |
| 15.2 | 84.8 | 32.0 |
| 16.0 | 84.0 | 32.0 |
| 16.7 | 83.3 | 31.8 |
| 17.5 | 82.5 | 31.6 |
| 18.9 | 81.1 | 31.4 |
| 20.3 | 79.7 | 31.0 |
| 21.7 | 78.3 | 30.9 |
| 23.0 | 77.0 | 30.6 |
| 24.3 | 75.7 | 30.5 |
| 25.5 | 74.5 | 30.3 |
| 26.7 | 73.3 | 30.3 |
| 27.8 | 72.2 | 30.3 |
| 28.9 | 71.1 | 30.2 |
| 30.0 | 70.0 | 30.1 |
| 31.1 | 68.9 | 29.9 |
| 32.1 | 67.9 | 29.9 |
| 33.1 | 66.9 | 29.8 |
| 34.0 | 66.0 | 29.7 |
| 35.0 | 65.0 | 29.6 |
| 35.9 | 64.1 | 29.5 |
| 36.7 | 63.3 | 29.5 |
| 37.6 | 62.4 | 29.5 |
| 38.4 | 61.6 | 29.5 |
| 39.2 | 60.8 | 29.5 |
| 40.0 | 60.0 | 29.5 |
| 40.8 | 59.2 | 29.5 |
| 41.6 | 58.4 | 29.5 |
| 42.3 | 57.7 | 29.5 |
| 43.0 | 57.0 | 29.4 |
| 43.7 | 56.3 | 29.4 |
| 44.4 | 55.6 | 29.4 |
| 45.0 | 55.0 | 29.4 |
| 45.7 | 54.3 | 29.4 |
| 46.3 | 53.7 | 29.3 |
| 46.9 | 53.1 | 29.3 |
| 47.5 | 52.5 | 29.2 |
| 48.1 | 51.9 | 29.2 |
| 48.7 | 51.3 | 29.2 |
| 49.3 | 50.7 | 29.2 |
| 49.8 | 50.2 | 29.2 |
| 50.4 | 49.6 | 29.2 |
| 50.9 | 49.1 | 29.2 |
| 51.4 | 48.6 | 29.2 |
| 51.9 | 48.1 | 29.2 |
| 52.4 | 47.6 | 29.2 |
| 52.9 | 47.1 | 29.2 |
| 53.4 | 46.6 | 29.1 |
| 53.9 | 46.1 | 29.1 |
| 54.3 | 45.7 | 29.1 |
| 54.8 | 45.2 | 29.1 |
| 55.2 | 44.8 | 29.1 |
| 55.6 | 44.4 | 29.1 |
| 56.1 | 43.9 | 29.1 |
| 56.5 | 43.5 | 29.0 |
| 56.9 | 43.1 | 29.0 |
| 57.3 | 42.7 | 29.0 |
| 57.7 | 42.3 | 29.0 |
| 58.1 | 41.9 | 29.0 |
| 58.4 | 41.6 | 29.0 |
| 58.8 | 41.2 | 29.0 |
| 59.2 | 40.8 | 29.0 |
| 59.5 | 40.5 | 29.0 |
| 59.9 | 40.1 | 29.0 |
| 60.2 | 39.8 | 29.0 |
| 60.6 | 39.4 | 29.0 |
| 60.9 | 39.1 | 29.0 |
| 61.2 | 38.8 | 29.0 |
| 61.6 | 38.4 | 29.0 |
| 61.9 | 38.1 | 29.0 |
| 62.2 | 37.8 | 29.0 |
| 62.5 | 37.5 | 29.0 |
| 62.8 | 37.2 | 29.0 |
| 63.1 | 36.9 | 29.0 |
| 63.4 | 36.6 | 29.0 |
| 63.7 | 36.3 | 29.0 |
| 64.0 | 36.0 | 29.0 |
| 64.2 | 35.8 | 29.0 |
| 64.5 | 35.5 | 29.0 |
| 64.8 | 35.2 | 29.0 |

TABLE 3

| Wt. % | Wt. % | Temp |
|---|---|---|
| CH₃I | cis-HFC-1234ze | (° C.) |
| 0.00 | 100.00 | 9.68 |
| 0.61 | 99.39 | 9.61 |
| 1.82 | 98.18 | 9.46 |
| 5.27 | 94.73 | 9.20 |
| 8.48 | 91.52 | 9.03 |
| 12.44 | 87.56 | 8.81 |
| 16.07 | 83.93 | 8.81 |
| 19.41 | 80.59 | 8.75 |
| 23.23 | 76.77 | 8.74 |
| 26.71 | 73.29 | 8.73 |
| 29.88 | 70.12 | 8.78 |
| 32.79 | 67.21 | 8.88 |
| 36.98 | 63.02 | 8.90 |
| 40.67 | 59.33 | 8.94 |
| 43.96 | 56.04 | 8.98 |
| 46.90 | 53.10 | 9.11 |
| 49.55 | 50.45 | 9.14 |
| 51.94 | 48.06 | 9.16 |
| 54.12 | 45.88 | 9.17 |

TABLE 4

| Wt. % | Wt. % | |
|---|---|---|
| CH₃I | HFO-1233zd(E) | T(C.) |
| 0.00 | 100.00 | 17.75 |
| 0.56 | 99.90 | 17.75 |
| 1.67 | 98.78 | 17.74 |
| 3.81 | 96.63 | 17.74 |
| 5.86 | 94.57 | 17.76 |
| 9.72 | 90.70 | 17.81 |
| 14.11 | 86.29 | 17.90 |
| 18.09 | 82.29 | 17.99 |
| 23.75 | 76.60 | 18.12 |
| 28.68 | 71.65 | 18.20 |

Suitable surfactants for use in fumigant compositions can be ionic surfactants or non-ionic surfactants. In at least some examples, the surfactant can be a non-ionic surfactant. Non-ionic surfactants that can be suitable in fumigant compositions include, but are not limited to: Arkopal™ , Cetomacrogol™ 1000, cetostearyl alcohol, cetyl alcohol, cocamide DEA, cocamide MEA, decyl glucoside, glyceryl laurate, lauryl glucoside, narrow range ethoxylates, nonoxynols, NP-40, octaethylene glycol monododecyl ether, octyl glucoside, oleyl alcohol, pentaethylene glycol, monododecyl ether, poloxamer, polyglycerol polyricinoleate, polysorbate, polysorbate 20, polysorbate 40, polysorbate 60, polysorbate 80, sorbitan monostearate, sorbitan tristearate, stearyl alcohol, Triton™ X-100, and Tween™ 80. In one specific example, the surfactant can be a polysorbate, which can be polysorbate 20, polysorbate 40, polysorbate 60 or polysorbate 80.

Fumigant compositions can also include at least one additive. Suitable additives for the fumigant compositions include, but are not limited to, chloropicrin, acrolein, 1,3-dichloropropene, dimethyl disulfide, furfural, and propylene oxide.

The fumigant compositions described herein can be utilized in drip fumigation processes. Specifically, a fumigant composition can be provided to an irrigation system and applying the fumigant composition to soil through the irrigation system. The irrigation system can include one or more dripperlines having a plurality of emitters therein. The emitters, also known as drippers, can be of any suitable type, including for example pre-punched holes or porous pipe. The emitters can be formed as an integral part of a dripperline, or can be separately produced and installed on or in the one or more dripperlines. The emitters can be spaced apart at any suitable distance, including for example, from about 8 inches apart to about 24 inches apart (from 200 mm to 600 mm apart). In some examples, the one or more dripperlines can be placed below the soil that is to be fumigated. The application of the fumigant composition to the soil can include providing pressure to cause the fumigant composition to flow through the one or more dripperlines and exit the one or more dripperlines through the plurality of emitters to contact and flow into the soil.

After drip application through an irrigation system, the behavior of fumigant compositions is a function of their water solubility, volatility, hydrolysis and degradation rates, and their sorption to soil organic matter and clay. The physical and chemical properties of the fumigants, such as: water solubility, vapor pressure, boiling point, Henry's constant and half life in soil, are good indicators of how each chemical will behave in the soil-air-water system. The efficacy of a fumigant correlates to its distribution patterns in soils and applications that maximize concentrations in the pest-infested zone give better control.

For example, methyl bromide and methyl iodide have similar biological activity, but their physico-chemical properties are different enough that they behave differently in drip fumigant applications.

| | Water Vapor | Boiling | | Henry's |
|---|---|---|---|---|
| | Solubility | Pressure | Boiling Point | Constant |
| | (%, wt/wt) | (mm Hg) | (° C.) | (air/water) |
| Methyl Bromide | 1.34 | 1420 | 4 | 0.244 |
| Methyl Iodide | 1.40 | 400 | 42 | 0.210 |

Studies have shown that in drip fumigation applications, methyl bromide tends to diffuse rapidly through the soil in all directions for the first few hours after application. Methyl iodide, on the other hand, has a slower rate of diffusion. After 72 hours, methyl iodide has been shown to be more confined to the layers adjacent to the depth of placement than methyl bromide. Methyl bromide consistently spread out more rapidly than methyl iodide, which is likely due to the differences in their boiling points and diffusion rates. After 120 hours, concentrations of methyl iodide were shown to be higher than methyl bromide at most depths, thus indicating less volatilization from the soil surface. The slower movement of methyl iodide in the soil profile and lower level of volatilization from the soil surface on the same time scale indicates a greater possibility of groundwater contamination due to the use of methyl iodide. For example, if the surface sealing through use of the plastic mulch or film is sufficient, or under certain conditions such as a shallow water table or heavy rain events shortly after soil fumigation, then the downward migration of methyl iodide in the soil profile could lead to groundwater contamination. Groundwater contamination by fumigants has toxicological significance due to their acute toxicity, probable carcinogenicity or other adverse effects. For instance, discovery of residues in groundwater led to the ban of ethylene dibromide (EDB) and 1,2-dibromo-3-chloroporpane (DBCP) in the early 1980's.

Without being bound by any particular theory, it is believed that increasing the volatility of a fumigant composition reduces the risk of groundwater contamination. The following examples provide testing that was done to determine the volatility of various fumigant compositions.

### EXAMPLES

Procedure for determining chemical volatilization:

A 500 mL chilled Fischer Porter tube equipped with a sample port to permit periodic removal of headspace samples, and a purge line with a flow meter and needle to control the nitrogen flow, was utilized as the experimental apparatus to determine chemical volitalization of various compositions containing methyl iodide. In each experiment, the tube was cooled to 0° C. and charged with varying amounts of water, surfactant, methyl iodide and 245fa. Temperature was equilibrated to 20° C. and nitrogen flow set at about 25 mL/min to about 30 mL/min. Headspace samples were taken at ten minute intervals for the first two hours, and then every hour thereafter for a total of eight hours, a final sample was taken after 24 hours. The headspace samples were analyzed on a HP5890 GC using a BD 1301 capillary column.

Experiment 1: About 30.18 grams of methyl iodide was added to about 101.18 grams of water in the apparatus and headspace samples were taken periodically in accordance with the procedure described above. After 24 hours, a methyl iodide layer was observed at the bottom of the experimental vessel.

Experiment 2: About 31.36 grams of methyl iodide and about 10.26 grams of Tween™ 80, a surfactant, were added to about 101.18 grams of water in the apparatus and headspace samples were taken periodically in accordance with the procedure described above. After 24 hours, a methyl iodide layer was observed at the bottom of the experimental vessel.

Experiment 3: About 26.8 grams of methyl iodide and about 38.4 grams of HFC-245fa, a hydrofluorocarbon, were added as an azeotropic or azeotropic-like mixture to about 102.13 grams of water in the apparatus and headspace samples were taken periodically in accordance with the procedure described above. After 24 hours, a small lower layer was observed at the bottom of the experimental vessel.

Experiment 4: About 26.3 grams of methyl iodide and about 24.75 grams of HFC-245fa were added as an azeotropic or azeotropic-like mixture to about 10.32 grams of Tween™ 80 and about 90.05 grams of water in the apparatus and headspace samples were taken periodically in accordance with the procedure described above. After 24 hours, no layer was observed at the bottom of the experimental vessel.

The analytical results for Experiments 1 through 4 are set forth in Table 5 below:

TABLE 5

| Experiment | Composition | MeI: | 245fa: |
|---|---|---|---|
| No. | Components | % Volatized | % Volatized |
| 1 | MeI | 15 | 0 |
| 2 | MeI/surfactant | 16 | 0 |
| 3 | MeI/HFC-245fa | 57 | 24 |
| 4 | MeI/HFC-245fa/ | 100 | 100 |
| | surfactant | | |

Experiment 1 determined the baseline for methyl iodide volatilization in the experimental apparatus. It was demonstrated that when only methyl iodide was present, only 13% of the total chemical added to water was volatilized over the course of the experiment. The remaining methyl iodide separated from the water and formed a separate layer at the bottom of the apparatus.

Experiment 2 demonstrated that the amount of methyl iodide volatilized is doubled when a surfactant is used in the water layer. The presence of the surfactant resulted in an increased the amount of methyl iodide being dissolved in the water layer, and thus increased the surface area between the fumigant liquid and the gas passing through the experimental apparatus.

Experiment 3 demonstrated that the when methyl iodide is mixed with the hydrofluorocarbon HFC-245fa in water, approximately 57% of the methyl iodide was evaporated from the water solution. The hydrofluorocarbon and methyl iodide form a low boiling azeotrope, which is more volatile than methyl iodide alone, which resulted in the increased amount of methyl iodide removed from the water solution. The hydrofluorocarbon could also be labeled a volatilizer.

Experiment 4 demonstrated that by combining the azeotropic mixture of methyl iodide and HFC-245fa with the surfactant, all of the fumigant was removed from the water layer. Without being bound by any particular theory, it is believed that these conditions increased the fraction of fumigant that was volatized due to the synergistic effect of the volatility of the azeotropic mixture and an increased amount of the azeotropic mixture being dissolved in the water layer due to the presence of the surfactant, thus providing an increased total surface area between the azeotropic mixture and the gas passing through the water layer.

From the foregoing, it will be appreciated that although specific examples have been described herein for purposes of illustration, various modifications may be made without deviating from the spirit or scope of this disclosure. It is therefore intended that the foregoing detailed description be regarded as illustrative rather than limiting, and that it be understood that it is the following claims, including all equivalents, that are intended to particularly point out and distinctly claim the claimed subject matter.

What is claimed is:

1. A fumigant composition comprising:
methyl iodide;
at least one fluorocarbon or hydrofluorocarbon;
at least one surfactant; and
water.

2. The fumigant composition of claim 1, wherein the at least one fluorocarbon or hydrofluorocarbon is selected from the group consisting of HFC-245fa, HFC-365, cis-HFC-1234ze, and HFO-1233zd(E).

3. The fumigant composition of claim 1, wherein the surfactant is non-ionic.

4. The fumigant composition of claim 1, wherein the surfactant is selected from the group consisting of Arkopal™ , Cetomacrogol™ 1000, cetostearyl alcohol, cetyl alcohol, cocamide DEA, cocamide MEA, decyl glucoside, glyceryl laurate, lauryl glucoside, narrow range ethoxylates, nonoxynols, NP-40, octaethylene glycol monododecyl ether, octyl glucoside, oleyl alcohol, pentaethylene glycol, monododecyl ether, poloxamer, polyglycerol polyricinoleate, polysorbate, polysorbate 20, polysorbate 40, polysorbate 60, polysorbate 80, sorbitan monostearate, sorbitan tristearate, stearyl alcohol, Triton™ X-100, and Tween™ 80.

5. The fumigant composition of claim 3, wherein the surfactant is a polysorbate.

6. A method of making a fumigant composition, the method comprising the steps of:
providing an initial mixture that includes methyl iodide and at least one fluorocarbon or hydrofluorocarbon; and
combining the initial mixture with at least one surfactant and water to form a fumigant composition.

7. The method of making a fumigant composition of claim 6, wherein the at least one fluorocarbon or hydrofluorocarbon is selected from the group consisting of HFC-245fa, HFC-365, cis-HFC-1234ze, and HFO-1233zd(E).

8. The method of making a fumigant composition of claim 6, wherein the initial mixture is an azeotropic or azeotrope-like mixture of the methyl iodide and the at least one fluorocarbon or hydrofluorocarbon.

9. The method of making a fumigant composition of claim 6, wherein the initial mixture, wherein the initial mixture consists essentially of the methyl iodide and at least one fluorocarbon or hydrofluorocarbon.

10. The method of making a fumigant composition of claim 6, wherein the initial mixture further comprises at least one additive selected from the group consisting of chloropicrin, acrolein, 1,3-dichloropropene, dimethyl disulfide, furfural, and propylene oxide.

11. The method of making a fumigant composition of claim 6, wherein the surfactant is non-ionic.

12. The method of making a fumigant composition of claim 6, wherein the surfactant is selected from the group consisting of Arkopal™ , Cetomacrogol™ 1000, cetostearyl alcohol, cetyl alcohol, cocamide DEA, cocamide MEA, decyl glucoside, glyceryl laurate, lauryl glucoside, narrow range ethoxylates, nonoxynols, NP-40, octaethylene glycol monododecyl ether, octyl glucoside, oleyl alcohol, pentaethylene glycol, monododecyl ether, poloxamer, polyglycerol polyricinoleate, polysorbate, polysorbate 20, polysorbate 40, polysorbate 60, polysorbate 80, sorbitan monostearate, sorbitan tristearate, stearyl alcohol, Triton™ X-100, and Tween™ 80.

13. The method of making a fumigant composition of claim 12, wherein the surfactant is a polysorbate.

14. A fumigant composition made in accordance with the method of claim cm 6.

15. A method of drip fumigating soil, the method comprising the steps of:
providing a fumigant composition to an irrigation system, the fumigant composition including methyl iodide, at least one fluorocarbon or hydrofluorocarbon, at least one surfactant, and water; and
applying the fumigant composition to soil through the irrigation system.

16. The method of drip fumigating soil of claim 15, wherein the step of providing a fumigant composition includes forming a fumigant composition by:
providing an initial mixture that includes methyl iodide and at least one fluorocarbon or hydrofluorocarbon; and
combining the initial mixture with at least one surfactant and water to form a fumigant composition.

17. The method of drip fumigating soil of claim 15, wherein the at least one fluorocarbon or hydrofluorocarbon is selected from the group consisting of HFC-245fa, HFC-365, cis-HFC-1234ze, and HFO -1233zd(E).

18. The method of drip fumigating soil of claim 15, wherein the surfactant is non-ionic.

19. The method of drip fumigating soil of claim 15, wherein the surfactant is selected from the group consisting of Arkopal™ , Cetomacrogol™ 1000, cetostearyl alcohol, cetyl alcohol, cocamide DEA, cocamide MEA, decyl glucoside, glyceryl laurate, lauryl glucoside, narrow range ethoxylates, nonoxynols, NP-40, octaethylene glycol monododecyl ether, octyl glucoside, oleyl alcohol, pentaethylene glycol, monododecyl ether, poloxamer, polyglycerol polyricinoleate, polysorbate, polysorbate 20, polysorbate 40, polysorbate 60, polysorbate 80, sorbitan monostearate, sorbitan tristearate, stearyl alcohol, Triton™ X-100, and Tween™ 80.

20. The method of drip fumigating soil of claim 19, wherein the surfactant is a polysorbate.
